(19) United States
(12) Patent Application Publication
(10) Pub. No.: US 2026/0329634 A1
(43) Pub. Date: Oct. 22, 2026

(54) PLASMA CONTROL SYSTEM TEST PLATFORM, TEST METHOD, AND STORAGE MEDIUM

(71) Applicant: HEFEI INSTITUTES OF PHYSICAL SCIENCE, CHINESE ACADEMY OF SCIENCES, Hefei (CN)

(72) Inventors: Qiping YUAN, Hefei (CN); Xueliang LIU, Hefei (CN); Junjie HUANG, Hefei (CN); Ruirui ZHANG, Hefei (CN)

(73) Assignee: HEFEI INSTITUTES OF PHYSICAL SCIENCE, CHINESE ACADEMY OF SCIENCES, Hefei (CN)

(21) Appl. No.: 19/445,086

(22) Filed: Jan. 9, 2026

(30) Foreign Application Priority Data
Apr. 18, 2025 (CN) 202510491369.5

(51) Int. Cl. G06F 9/48; G06F 9/451

(52) U.S. Cl. CPC G06F 9/4881; G06F 9/451

(57) ABSTRACT

This disclosure discloses a plasma control system test platform, a test method, and a storage medium, relating to the technical field of test systems, specifically including: a client, provided with a task submission device and an interactive visualization device; a server, wherein a task upload device is configured to receive tasks uploaded by the client, and after parsing the tasks, sends them to a task queue scheduler; the task queue scheduler, according to priority, performs insertion or queuing of uploaded tasks; a multi-mode executor is connected to PCS and PCS-VP, the multi-mode executor obtains the head task of the task queue, and according to the task mode, starts a PCS process to execute the task or simultaneously starts PCS and PCS-VP processes to execute the task; after task execution is completed, a data analysis device is configured to obtain raw execution data, process the data, and feed the processed data back to the client interactive visualization device. It aims to achieve full-process dynamic interaction between the plasma control system and the main control system, meeting the complex demands of modern experimental testing.

### CROSS REFERENCE TO RELATED APPLICATIONS

This application claims priority to Chinese Patent Application No. 2025104913695, filed on Apr. 18, 2025, the entire content of which is incorporated herein in its entirety.

### TECHNICAL FIELD

The present disclosure relates to the technical field of test systems, and specifically, to a plasma control system test platform, a test method, and a storage medium.

### BACKGROUND

In fusion reactions, the plasma control system plays a crucial role. Its main task is to ensure the stable progress of the fusion reaction by precisely controlling plasma parameters (such as temperature, density, and magnetic field). However, the high temperature, high energy, and complexity of plasma make the stability and reliability of its control system a decisive factor for the success of fusion experiments. Therefore, how to improve the testing and verification efficiency of the plasma control system and ensure its reliability in actual experiments is a major issue in current fusion experiment research.

Currently, in traditional fusion experiment test systems, testing and verification often rely on manual operations. In this process, test personnel need to manually modify test configuration files and execute a series of test procedures step by step. This manual operation method is not only cumbersome and time-consuming but also susceptible to human factors, leading to errors and uncertainties in the test process, thereby affecting the accuracy and reliability of test results. Furthermore, traditional test methods usually lack the support of automated testing tools and rely on a single test mode, unable to construct full-process dynamic interaction between the plasma control system and the main control system, and unable to monitor and adjust the system's interactive behavior in real time. This limitation makes real-time feedback and adjustment difficult during the testing process, failing to fully discover and resolve potential system issues, which greatly limits the comprehensiveness and real-time nature of testing.

Therefore, how to achieve full-process dynamic interaction between the plasma control system and the main control system to meet the complex demands of modern experimental testing has become a technical problem that urgently needs to be solved.

### SUMMARY

The main objective of the present disclosure is to provide a plasma control system test platform, a test method, and a storage medium. It aims to achieve full-process dynamic interaction between the plasma control system and the main control system and meet the complex demands of modern experimental testing.

To achieve the above objective, the present disclosure proposes a plasma control system test platform, including:
a client, provided with a task submission device and an interactive visualization device, wherein the task submission device is configured to support single task form configuration and/or batch task file upload;
a server, provided with a task upload device, a task queue scheduler, a multi-mode executor, and a data analysis device; wherein the task upload device is configured to receive tasks uploaded by the client, and after parsing the tasks, send them to the task queue scheduler; the task queue scheduler, according to priority, performs insertion or queuing of uploaded tasks; the multi-mode executor is connected to PCS and PCS-VP, the multi-mode executor obtains the head task of the task queue, and according to the task mode, starts a PCS process to execute the task or simultaneously starts PCS and PCS-VP processes to execute the task; after task execution is completed, the data analysis device obtains raw execution data, processes the data, and feeds the processed data back to the client interactive visualization device.

In an embodiment of the present disclosure, according to priority, performing insertion or queuing of uploaded tasks includes:
the task queue scheduler is configured to obtain task priority, determine whether the current priority is a privileged task; if it is a privileged task, query whether there is an uncompleted privileged task in the current queue; if there is an uncompleted privileged task, insert the new privileged task after the most recent privileged task; if there is no uncompleted privileged task, insert the new privileged task at the head of the queue;
if it is not a privileged task, the task queue scheduler is configured to insert the task at the tail of the queue, and after task execution is completed, delete the head task and update the database status field.

In an embodiment of the present disclosure, the task mode includes: a scenario replay mode and a simulation test mode;
when the multi-mode executor determines that the mode is the scenario replay mode, it modifies the PCS operating mode to runsa in the configuration file, starts the PCS process, calls a simulated central control system device to generate a hardware trigger signal, and the signal outputs a high-level pulse through an NI I/O card;
when the multi-mode executor determines that the mode is the simulation test mode, it modifies the PCS operating mode to runsim in the configuration file, starts the PCS and PCS-VP processes; transmits control signals to PCS-VP through shared memory, and receives simulated acquisition signals and feeds them back to PCS to form a closed loop.

In an embodiment of the present disclosure, processing the data, and feeding the processed data back to the client interactive visualization device includes:
the data analysis device reads experimental shot data and historical reference shot data from a database storing raw execution data, identifies flat-top segments in the experimental shot data and historical reference shot data, performs flat-top segment waveform analysis and boundary offset Euclidean distance calculation, stores intermediate results as target format files, records the paths in a test shot table in the database, and feeds analysis results back to the client's interactive visualization device, wherein the interactive visualization device displays visual charts.

In an embodiment of the present disclosure, the client is further provided with a document generation device, wherein the document generation device obtains the paths of the visual charts displayed by the interactive visualization device, a summary of analysis results, and custom annotations, calls a general large language model to integrate the visual charts, the summary of analysis results, and the custom annotations, and generates a structured document.

In an embodiment of the present disclosure, the server is further provided with a status monitor device, wherein the status monitor device subscribes to health information of PCS published by an open-source distributed control system framework, integrates the platform's own operating status, pushes the integrated status data to the client through WebSocket, and triggers real-time refresh of the client interface.

In an embodiment of the present disclosure, the client is provided with an identity authentication device, the server is provided with an identity verification device, wherein the identity verification device receives identity data from the identity authentication device, when the identity data is for new user registration, stores the identity data, and feeds back a registration result; when the identity data is historical data, compares the identity data with its own database, and distributes corresponding permissions.

In an embodiment of the present disclosure, the permissions include: administrator, core developer, and ordinary developer.

The present disclosure also discloses a plasma control system test method, including the following steps:
S1. submitting, by a user, single task form configuration and/or batch task files through a client;
S2. verifying, by a server, permissions and scheduling tasks to a queue;
S3. dynamically adjusting, by a multi-mode executor, PCS operating parameters according to task configuration;
S4. collecting, by a status monitor, health data of PCS in real time and pushing it to the client;
S5. processing, by a document generation device, test results, and generating visual charts and an automated report.

The present disclosure also discloses a non-transitory computer-readable storage medium, storing a computer program that, when executed by a processor, causes the processor to implement the steps of the method as described above.

By adopting the above technical solution, the plasma control system test platform of the present disclosure can efficiently manage and execute test tasks for the plasma control system by integrating multiple functions such as task submission, queue scheduling, task execution, and data analysis. Through clear functional division of labor and close collaboration between the client and the server, users can conveniently submit tasks and view test results in real time, while the system can reasonably schedule tasks according to their priority and type, thereby improving test efficiency and resource utilization.

### BRIEF DESCRIPTION OF THE DRAWINGS

The present disclosure is described in detail below with reference to specific embodiments and accompanying drawings, wherein:

FIG. 1 is a schematic diagram of the system structure according to a first embodiment of the present disclosure;

FIG. 2 is a schematic diagram of the process structure according to the present disclosure.

### DETAILED DESCRIPTION

To make the objectives, technical solutions, and advantages of the present disclosure clearer, the present disclosure is described in detail below with reference to the accompanying drawings and embodiments. It should be understood that the following specific embodiments are only used to explain the present disclosure and do not limit the present disclosure.

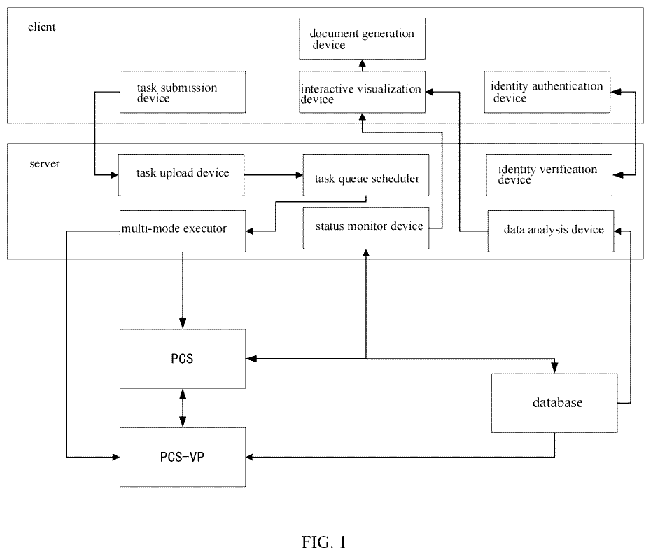

As shown in FIG. 1, to achieve the above objective, the present disclosure proposes a plasma control system test platform, including:
a client, provided with a task submission device and an interactive visualization device, wherein the task submission device is configured to support single task form configuration and/or batch task file upload;
a server, provided with a task upload device, a task queue scheduler, a multi-mode executor, and a data analysis device; wherein the task upload device is configured to receive tasks uploaded by the client, and after parsing the tasks, send them to the task queue scheduler; the task queue scheduler is configured to, according to priority, perform insertion or queuing of uploaded tasks; the multi-mode executor is connected to PCS and PCS-VP (Plasma Control System Verification Platform), the multi-mode executor is configured to obtain the head task of the task queue, and according to the task mode, start a PCS process to execute the task or simultaneously start PCS and PCS-VP processes to execute the task; after task execution is completed, the data analysis device is configured to obtain raw execution data, process the data, and feed the processed data back to the client interactive visualization device.

Specifically, the task submission device is configured to support two task upload methods. The first method is single task form configuration, where the user fills in relevant parameters of the task through the client interface, such as test type, test mode, etc. The second method is batch task file upload, where the user selects a file containing multiple task configurations, and the client performs format validation on the file to ensure the file content complies with the specified format. If the file format meets the requirements, the client parses it into JSON format and uploads it to the task upload device of the server.

The interactive visualization device is configured to receive the data processed by the data analysis device and display it graphically. The display content includes, but is not limited to, the execution status of test tasks, task results, etc. The user can view the task execution process and its results in real time in this device, and perform interactive operations such as zooming in, zooming out, or selecting specific data for detailed analysis.

The server includes a task upload device, a task queue scheduler, a multi-mode executor, and a data analysis device.

The task upload device is configured to receive single tasks or batch task files uploaded from the client and parse them. For single task form configuration, the task upload device is configured to parse the form content into JSON format data; for batch task file upload, the task upload device is configured to parse the file content and convert it into JSON format data, then send the parsed task data to the task queue scheduler.

The task queue scheduler manages the task queue according to the priority of the tasks. The task priority is set by the client during task upload and can be divided into high priority and regular priority. The task queue scheduler sorts tasks according to their priority and decides whether to insert tasks into the queue based on their priority. If there is a high-priority task, the task queue scheduler will insert this task at the head of the queue; if it is a regular task, it will be inserted at the tail.

The multi-mode executor is configured to start and manage the task execution process of the plasma control system PCS and PCS-VP. The multi-mode executor obtains the head task of the task queue and, according to the task mode, decides whether to start only the PCS process to execute the task or to simultaneously start the PCS process and the PCS-VP process to execute the task. If the task mode is scenario replay test, only the PCS process is started; if the task mode is simulation test, both the PCS process and the PCS-VP process are started. During execution, the coordination and data exchange between PCS and PCS-VP are completed through specific interfaces to ensure the synchronization and accuracy of task execution.

After the task execution is completed, the data analysis device is configured to obtain the raw execution data from the PCS or PCS-VP processes. The data analysis device is configured to process the data, including but not limited to data cleaning, calculation analysis, result evaluation, etc. The processed data is sent to the client's interactive visualization device through a feedback mechanism for the user to view and analyze.

By adopting the above technical solution, the plasma control system test platform of the present disclosure can efficiently manage and execute test tasks for the plasma control system by integrating multiple functions such as task submission, queue scheduling, task execution, and data analysis. Through clear functional division of labor and close collaboration between the client and the server, users can conveniently submit tasks and view test results in real time, while the system can reasonably schedule tasks according to their priority and type, thereby improving test efficiency and resource utilization.

In an embodiment of the present disclosure, according to priority, performing insertion or queuing of uploaded tasks includes:
the task queue scheduler obtains task priority, determines whether the current priority is a privileged task; if it is a privileged task, queries whether there is an uncompleted privileged task in the current queue; if there is an uncompleted privileged task, inserts the new privileged task after the most recent privileged task; if there is no uncompleted privileged task, inserts the new privileged task at the head of the queue;
if it is not a privileged task, inserts the task at the tail of the queue, and after task execution is completed, deletes the head task and updates the database status field.

Specifically, the task queue scheduler first obtains the priority of the task. The task priority is set by the client during task submission. The priority is divided into two categories: “privileged task” and “non-privileged task”. Privileged tasks represent urgent or higher-priority test tasks, while non-privileged tasks are regular tasks with lower processing priority.

The task queue scheduler determines whether the task is a privileged task based on the task's priority identifier. If the current task is a privileged task, it enters the insertion processing flow for privileged tasks; if the current task is not a privileged task, it enters the regular task processing flow.

When the task queue scheduler determines that the current task is a privileged task, it first queries whether there are any uncompleted privileged tasks in the task queue. Each task in the task queue records its execution status (such as “pending”, “executing”, “completed”, etc.). An uncompleted privileged task refers to a task whose status is not “completed”.

If there are uncompleted privileged tasks in the task queue, the task queue scheduler inserts the newly submitted privileged task after the last uncompleted privileged task in the sequential queue. This operation ensures that privileged tasks are executed in the order of submission, avoiding conflicts between different privileged tasks. If there are no uncompleted privileged tasks in the queue, the new privileged task is directly inserted at the head of the queue, ensuring it is executed prior to other tasks.

If the current task is a non-privileged task, the task queue scheduler inserts it at the tail of the task queue. This ensures that regular tasks are executed in the order of submission but do not take precedence over privileged tasks. When the task at the head of the queue completes execution, the task queue scheduler deletes it from the queue and updates the task status field in the database. The update operation of the task status field includes marking the task status as “completed” and recording the task's execution time or other relevant information. The operation of updating the database ensures the synchronization of task execution history records and status of the system.

By adopting the above technical solution, the task queue scheduler can reasonably schedule tasks according to their priority. Privileged tasks can be executed preferentially, while regular tasks are executed in queue. This scheduling method not only ensures that urgent tasks are processed in time but also reasonably allocates system resources, improving task execution efficiency and system responsiveness. Through task status updates and reasonable queue management, the system can maintain good task execution order and operational status transparency, providing reliable support for subsequent data analysis and system optimization.

In an embodiment of the present disclosure, the task mode includes: a scenario replay mode and a simulation test mode;

when the multi-mode executor determines that the mode is the scenario replay mode, it modifies the PCS operating mode to runsa in the configuration file, starts the PCS process, calls a simulated central control system device to generate a hardware trigger signal, and the signal outputs a high-level pulse through a NI I/O card;

when the multi-mode executor determines that the mode is the simulation test mode, it modifies the PCS operating mode to runsim in the configuration file, starts the PCS and PCS-VP processes; transmits control signals to PCS-VP through shared memory, and receives simulated acquisition signals and feeds them back to PCS to form a closed loop.

Specifically, the multi-mode executor determines the execution mode of the task based on the mode of the head task obtained from the task queue. The task mode includes scenario replay mode and simulation test mode.

After obtaining the task, the multi-mode executor first identifies the mode of the task and selects different execution methods according to the mode.

If the task mode is determined to be scenario replay mode, the PCS configuration file needs to be modified first. The configuration file modification process includes setting the PCS operation mode to “runsa”. In this mode, PCS will replay historical data without performing real-time control. After the modification of configuration file is completed, the multi-mode executor starts the PCS process. In this mode, PCS performs processing based on the replayed historical data to simulate the process of historical experiments. To simulate the dynamic changes of historical scenarios, the multi-mode executor calls the simulated central control system device to generate a hardware trigger signal. This hardware trigger signal is a high-level pulse signal output by an NI I/O card. In this way, control signals can interact correctly between PCS and the hardware.

If the task mode is simulation test mode, the multi-mode executor first modifies the PCS configuration file, setting its operation mode to “runsim”. In this mode, PCS and PCS-VP work together to perform simulation control and simulated acquisition. After the modification of configuration file is completed, the multi-mode executor simultaneously starts the PCS process and the PCS-VP process. PCS is responsible for generating control signals, while PCS-VP is responsible for simulating the plasma response. To achieve real-time transmission of control signals, the multi-mode executor transmits the control signals generated by the PCS process to PCS-VP through shared memory. The shared memory mechanism ensures timely and stable data exchange between PCS and PCS-VP. After PCS-VP simulates the acquisition signals, the simulated acquisition signals are fed back to PCS to form a control closed loop. In this way, PCS can adjust the system based on the feedback signals from PCS-VP, achieving closed-loop control of the test task.

It can be envisioned that:

The system will be affected by various disturbance factors during actual operation. Random noise, offset error, and drift error are set to deal with disturbance factors that appear in the system, which are used to study the anti-interference ability of the control system and its tolerance to signal errors.

In this application, an error injection device is designed. The error injection device includes three error types to simulate the operation of PCS under different abnormal conditions, namely random noise, offset error, and drift error. Among them, random noise corresponds to unpredictable random fluctuations in the measurement signal, usually caused by thermal noise or environmental electromagnetic interference. Offset error corresponds to the constant deviation between the measured value and the true value, often caused by inaccurate sensor calibration or hardware aging. Drift error corresponds to the gradual deviation of the measurement system from the true value over time, usually caused by temperature changes or component aging.

In the random noise test, high-frequency random fluctuations are simulated by multiplying the signal by a random gain coefficient. The expression of the signal is:

xnoise(t)=x(t)·(1+α·r(t));
where x(t) is the original signal, a is the amplitude range of the random gain coefficient, and r(t) is a random noise signal with a mean of 0 and a variance of 1. The random noise test is used to evaluate the stability and anti-interference ability of the system under high-frequency random fluctuations.

The offset error test adds a fixed offset value β to the signal. Its signal model is:

xbias(t)=x(t)+β;
where x(t) is the original signal, and β is the constant offset value, used to simulate measurement deviations caused by sensor calibration errors or hardware aging. This test is configured to verify the control accuracy and error compensation capability of the system under conditions of constant deviation.

The drift error test introduces an offset amount γ(t) that gradually increases over time. The mathematical model of the signal is:

xdrift(t)=x(t)+γ(t);

where x(t) is the original signal, and γ(t) is a function that increases linearly with time, usually expressed as:

γ(t)=κ·t;
where κ is the drift rate, and t represents time. The drift error test is configured to simulate the situation where the measurement system gradually deviates from the true value during long-term operation. It focuses on studying the system's ability to track gradual changes in signals and its adaptability and robustness during long-term operation. Through the tests of the above three error types, the performance of the PCS under different abnormal conditions can be evaluated, providing a basis for the optimal design of the system.

The injected error test is mainly divided into two modes: anti-interference ability test and control ability test.

During the anti-interference ability test, PCS-VP reads historical discharge data from the database, converts the historical discharge data into 288-channel measurement signals through the ToRFM device, adds disturbances through the error injection device, and then transmits them back to the RT node in PCS through the RFMout device. After the user sets the threshold, the anti-interference ability of the algorithm can be determined by comparing the difference between the algorithm output after injection and before injection.

In the control ability test, a control closed loop is formed between PCS and PCS-VP, replacing the actual plasma with a simulation model. Control signals are input to PCS-VP, and PCS-VP outputs simulated acquisition signals. By modifying the signal and intensity of error injection through the error injection device, it can help users test the control ability of the PCS under abnormal conditions.

During the actual operation of the plasma, it is affected by various abnormal factors, leading to the occurrence of plasma disruption. The disruption phenomenon may cause serious consequences such as device damage. Therefore, an exception handling mechanism is introduced in PCS. To facilitate exception handling, an exception test unit is provided.

### Define PCS Abnormality Events:

Plasma current abnormality: the deviation between the measured plasma current and the target current exceeds the threshold.

Vertical displacement event: the growth rate of the plasma displacement in the vertical direction exceeds the threshold.

Disruption prediction: the system predicts a high possibility of plasma disruption.

Poloidal field coil current abnormality: the deviation between the poloidal field coil current and the target current exceeds the allowable range.

Poloidal field coil overcurrent: the current in the poloidal field coil exceeds the set maximum allowable value.

Power supply failure: detect whether there is a power abnormality or interruption through the power supply signal.

Electromagnetic diagnostic signal abnormality: signal abnormality from the electromagnetic self-diagnosis system.

RMP coil current abnormality: the deviation between the actual current of the RMP coil and the target current is too large.

RMP coil overcurrent: the current in the RMP coil exceeds the maximum set limit.

First wall hot spot warning: the surface temperature of the first wall component exceeds the warning threshold.

First wall hot spot fault: the surface temperature of the first wall component exceeds the fault threshold.

When the signal abnormality test unit in this application works, its principle is the same as the anti-interference ability test and control ability test. It only needs to replace the error injection device in the anti-interference ability test and control ability test with the signal abnormality test device to work. Since it has been described above, it will not be repeated here.

By adopting the above technical solution, the multi-mode executor can flexibly switch execution modes according to different task modes. In scenario replay mode, the system can accurately simulate the historical experiment process and trigger hardware signals, ensuring the accuracy of the replay; in simulation test mode, PCS and PCS-VP can work together to simulate the plasma response process through the interaction of control signals and simulated signals, ensuring the comprehensiveness and reliability of the test. Through precise control of the task mode, the platform can effectively support a variety of complex test requirements, improving test efficiency and accuracy.

In an embodiment of the present disclosure, processing the data, and feeding the processed data back to the client interactive visualization device includes:

the data analysis device is configured to read experimental shot data and historical reference shot data from a database storing raw execution data, identify flat-top segments in the experimental shot data and historical reference shot data, perform flat-top segment waveform analysis and boundary offset Euclidean distance calculation, store intermediate results as target format files, record the paths in a test shot table in the database, and feed analysis results back to the client's interactive visualization device, wherein the interactive visualization device is configured to display visual charts.

Specifically, the data analysis device is configured to first read experimental shot data and historical reference shot data from the database storing raw execution data. Experimental shot data refers to the data from the currently executed test task, while historical reference shot data is the data used for comparison and evaluation. The data analysis device is configured to select and read relevant data from the test shot table in the database as needed.

After reading the experimental shot data and historical reference shot data, the data analysis device is configured to process these data to identify the flat-top segments within them. The flat-top segment is a specific time period during the plasma discharge process. The data analysis device is configured to detect and mark these data through specific algorithms (such as signal analysis, waveform matching, etc.) to identify the start time and end time of the flat-top segment.

After identifying the flat-top segment, the data analysis device is configured to perform waveform analysis on the data of the flat-top segment. The purpose of this step is to compare the waveform characteristics of the experimental shot data and the historical reference shot data and analyze their performance during the flat-top segment. The data analysis device is configured to calculate the shape of the waveform, amplitude changes, and other relevant features, quantify these features, and form analysis results.

The data analysis device is also configured to calculate the boundary offset between the experimental shot and the historical reference shot. For this purpose, the data analysis device is configured to use the Euclidean distance algorithm to calculate the offset between the experimental shot data and the historical reference shot data by comparing the boundary positions of them during the flat-top segment. This calculation result is used to evaluate the deviation of the experimental data and evaluate the stability of the test task.

The analysis method is as follows:

Identify the start time tstart and end time tend of the flat-top segment. These times mark the flat-top segment of the plasma, and this part of the data will be used for subsequent offset calculation.

Process each time slice ti of the flat-top segment. The range of time slices is from tstart to tend. Each time slice ti corresponds to a set of boundary point data.

For each time slice ti, extract the reference boundary point set Bref(ti) and the error-introduced boundary point set Berr(ti).

Bref(ti)={(xref1, yref1), . . . , (xrefM, yrefM)}: represents the set of boundary points of the reference boundary at time slice ti, where each boundary point is represented by coordinates (xrefj, yrefj), and M is the number of reference boundary points. xrefj represents the x-axis coordinate value of the reference boundary point, and yrefj represents the y-axis coordinate value of the reference boundary point.

Berr (ti)={(xerr1, yerr1), . . . , (xerrN, yerrN)}: represents the set of boundary points of the boundary with error at time slice ti, where each boundary point is represented by coordinates (xerrk, yerrk), and N is the number of error boundary points. xerrk represents the x-axis coordinate value of the error boundary point, and yerrk represents the y-axis coordinate value of the error boundary point.

For the reference boundary and the error-introduced boundary, calculate the Euclidean distance between each pair of points.

For a reference boundary point (xrefj, yrefj), select the closest point (xerrk, yerrk) from the error-introduced boundary point set.

For each matched pair of reference boundary point and error boundary point, calculate the Euclidean distance di,j between them:

di,j=\sqrt{(xrefj−xerrk)²+(yrefj−yerrk)²}
where di,j is the Euclidean distance between the reference point (xrefj, yrefj) and the error point (xerrk, yerrk).

For time slice ti, calculate the average offset di after matching all reference boundary points with error boundary points:

$$di = \frac{1}{M} {\sum }_{j = 1}^{M} d i , j ;$$

where di is the average offset in time slice ti, and M is the number of boundary points in the reference boundary point set Bref(ti).

After completing the flat-top segment waveform analysis and boundary offset Euclidean distance calculation, the data analysis device is configured to store the intermediate calculation results as target format files. These results include waveform analysis data, boundary offset data, and other relevant data. The storage paths are recorded in the test shot table in the database for subsequent query and access.

After completing data processing, the data analysis device is configured to transmit the analysis results to the client's interactive visualization device through a feedback mechanism. The feedback data includes waveform analysis results, boundary offset analysis results, etc. The client generates corresponding visual charts based on these data. The interactive visualization device can be configured to dynamically display these charts, supporting user interaction with the data (such as zooming in, zooming out, viewing detailed data, etc.).

In the client's interactive visualization device, the user will be able to view charts generated based on the data analysis results. The charts can include flat-top segment waveform diagrams, boundary offset diagrams, etc., displaying the time variation of the data, feature comparison, and boundary changes, among other information. Through interactive operations, the user can select different experimental shot data and reference shot data for comparative analysis, facilitating real-time evaluation of experimental results and making adjustments.

By adopting the above technical solution, the data analysis device can be configured to accurately identify the flat-top segment and perform waveform analysis and boundary offset calculation through automated processing and analysis of experimental shot data and historical reference shot data. By storing the analysis results and feeding them back to the client's interactive visualization device, the user can view the charts and data analysis results in real time. This visual display not only enhances the data analysis capability of the test platform but also improves the user's intuitive perception of data changes during the task execution process, helping to further optimize the test process and experimental design.

In an embodiment of the present disclosure, the client is further provided with a document generation device, wherein the document generation device is configured to obtain the paths of the visual charts displayed by the interactive visualization device, a summary of analysis results, and custom annotations, call a general large language model to integrate the visual charts, the summary of analysis results, and the custom annotations, and generate a structured document.

Specifically, the document generation device is configured to first obtain the paths of the visual charts displayed by the interactive visualization device. These paths point to the chart files viewed by the user on the client. These charts display the analysis results of the test task, such as flat-top segment waveform diagrams, boundary offset diagrams, etc. The document generation device is configured to interact with the interface of the interactive visualization device to obtain the path information of these charts.

After obtaining the paths of the visual charts, the document generation device also needs to be configured to obtain the summary of analysis results corresponding to the charts. These summaries are brief summaries of outputs from the data analysis device, including an overview of the data analysis results, evaluation conclusions, and key findings, etc. The summary of analysis results provides necessary background information for the document content, enabling users to quickly understand the main points of the analysis results.

In addition to the summary of analysis results and chart paths, the document generation device also needs to be configured to obtain custom annotations made by the user on the client. These annotations include the user's explanations of the test process, personal insights into the data analysis, or special points of interest regarding the results. Custom annotations provide personalized explanations and background information from the user, making the final generated document more comprehensive and in line with user needs.

The document generation device is configured to use a general large language model (such as the DeepSeek series models) to integrate the obtained content. The large language model first converts the paths of the visual charts, the summary of analysis results, and the custom annotations into structured content, and then integrates these contents into a structured document according to a certain logical order. The document generation process includes detailed descriptions of the analysis results, explanations of the charts, and the organization and integration of user custom annotations.

The content integrated by the general large language model will be converted into a structured document. The structured document includes components such as titles, chapters, charts, text descriptions, and annotations, with standardized formatting that is easy for users to understand and use further. The document generation device is configured to ensure that the document content is well-organized and uniformly formatted, and embeds the charts and analysis results into the document in an appropriate manner, facilitating user viewing and archiving.

The generated structured document will be stored on the server, and the client can download the document through the corresponding download interface. The document can be saved in PDF, Word, or other common formats. Users can download, store, or print it as needed.

By adopting the above technical solution, the document generation device can be configured to automatically integrate the charts displayed by the interactive visualization device, the summary of data analysis results, and user custom annotations into a structured document. This process not only reduces the workload of manual document writing but also improves the efficiency and accuracy of document generation. With the powerful integration capability of the general large language model, the generated document content has high quality and can meet user needs in areas such as test result archiving and report generation. This automated document generation method enhances the user experience, enabling the test platform to not only provide real-time data analysis but also provide efficient document output support for users.

In an embodiment of the present disclosure, the server is further provided with a status monitor device, wherein the status monitor device is configured to subscribe to health information of PCS published by an open-source distributed control system framework, integrates the platform's own operating status, pushes the integrated status data to the client through WebSocket, and triggers real-time refresh of the client interface.

Specifically, the status monitor device is configured to first subscribe to and obtain the health information of PCS (Plasma Control System) through an open-source distributed control system framework. The open-source distributed control system framework regularly publishes PCS health status data, including but not limited to the operating status, equipment health status, connection status, etc. of the system The status monitor device is configured to receive the PCS health data through the framework interface to ensure real-time acquisition of the latest system health status.

In addition to subscribing to health information of PCS, the status monitor device also needs to be configured to integrate the platform's own operating status. These status data include but are not limited to CPU usage, memory usage, disk space, network connection status, etc. of the system. The status monitor device is configured to regularly check and collect the platform's own operating data and integrate them with the health information of PCS. The integrated data can comprehensively reflect the health status of the system and the platform, ensuring the comprehensiveness and accuracy of monitoring.

After integrating the health information of PCS and the platform operating status, the status monitor device is configured to push these integrated status data to the client through WebSocket technology. WebSocket is a bidirectional communication protocol that allows the server and the client to establish a persistent connection, so that data can be immediately pushed to the client when the status of the server changes. The status monitor device is configured to use WebSocket to push real-time data such as health information and operating status of the platform and PCS to the client, ensuring that users can see operating status of the system in real time on the client interface.

After the client receives the pushed status data through WebSocket, it triggers a real-time refresh of the interface. The interactive interface of the client updates the display content based on the latest received status data. For example, the client may display different warnings or prompt information based on the system health status or dynamically display the usage conditions of system resources. This enables users to instantly understand the operating status of the system, discover potential system problems in a timely manner, and improve maintainability and responsiveness of the system.

By adopting the above technical solution, the status monitor device can be configured to obtain health information of PCS and the platform's own operating status in real time, and efficiently push these data to the client through WebSocket technology, triggering real-time interface refresh. This real-time status monitoring method not only improves the monitoring capability of the platform but also effectively helps users understand the status of the system in a timely manner, identify problems in advance, and handle them. Through real-time feedback of system health data, users can maintain complete control over the platform status during the testing process, improving reliability and maintenance efficiency of the system.

In an embodiment of the present disclosure, the client is provided with an identity authentication device, the server is provided with an identity verification device, wherein the identity verification device is configured to receive identity data from the identity authentication device, when the identity data is for new user registration, store the identity data, and feed back a registration result; when the identity data is historical data, compare the identity data with its own database, and distribute corresponding permissions.

Specifically, the client is provided with an identity authentication device. When the user performs identity authentication on the client, they confirm their identity by entering identity data such as username and password. The identity authentication device is configured to first check the credential data entered by the user. When the identity data entered by the user has not been registered in the system, the identity authentication device is configured to determine this data as new user registration. The system guides the user into the registration process and requires the user to provide necessary personal information (such as username, password, email, etc.). When the identity data entered by the user matches an existing user in the system, the identity authentication device is configured to determine this identity data as historical data and continues to process the login verification.

The server is provided with an identity verification device. This device is configured to receive the identity data transmitted from the client's identity authentication device. The identity verification device is configured to perform corresponding operations based on different identity data:

If the identity data transmitted by the identity authentication device is for new user registration, the identity verification device is configured to receive this identity data and store it in the server's database. All user information is stored using encryption technology to ensure data security. Once the user registration is successful, the identity verification device is configured to create account information of the new user, store their username, password, and other relevant data, ensuring the uniqueness and security of the user's identity in the system. After the storage process is completed, the identity verification device is configured to feed back the registration result to the client, including whether the registration was successful and related prompts. If the registration fails, the client will prompt the user to check the input information and resubmit the information.

If the identity data transmitted by the identity authentication device is historical user data, the identity verification device is configured to compare the transmitted identity data with the existing user data in its own database. The comparison includes whether the username and password match, etc. If the comparison is successful, it means the identity verification is passed. The identity verification device is configured to distribute corresponding permissions based on the user's role and permission information. These permissions determine the scope of operations the user can perform in the system (such as administrator, core developer, ordinary developer, etc.). After permission allocation, the identity verification device is configured to transmit the corresponding permission information back to the client. The client controls the user's operation interface and function access based on the permissions.

By adopting the above technical solution, the identity authentication and identity verification devices can effectively manage user identity and permissions. When a new user registers, the system can securely and conveniently store user data and feed back registration results; when a historical user logs in, the system quickly verifies the user's identity by comparing identity data with the database and assigns corresponding permissions according to the role of the user. This mechanism not only improves the security of the system and user experience but also ensures the rationality of permission allocation and the stable operation of the system. At the same time, the management and authentication process of user identity complies with best practices for data protection, ensuring the security of user information.

In an embodiment of the present disclosure, the permissions include: administrator, core developer, and ordinary developer.

Specifically, the administrator can add, delete, and modify user information, assign or adjust user roles. The administrator can create new user accounts, modify existing user permissions, or delete user accounts that are no longer needed. The administrator can view, modify, and delete all test tasks. The administrator can manually start, pause, or terminate test tasks and can view the execution results of all tasks. The administrator can adjust the system configuration, such as platform parameter settings, test mode definitions, etc. These operations ensure that the platform can be flexibly configured according to actual needs.

Core developers can create, modify, and delete test tasks related to themselves. Core developers can execute and schedule test tasks and view the execution status and test results of tasks. Core developers have the permission to insert tasks into the queue. They can insert test tasks they submitted into the priority position of the task queue to ensure that urgent tasks can be processed preferentially.

Ordinary developers can submit test tasks through the client but cannot modify other tasks in the task queue. Ordinary developers can only submit and view tasks related to themselves and cannot insert tasks into the queue or modify task priorities. Ordinary developers can view the execution status and results of tasks they submitted but cannot view test task data of other users.

By adopting the above technical solution, the permission management system can ensure that users of different roles obtain corresponding operation permissions according to their responsibilities. Administrators can fully control the system, core developers can flexibly manage test tasks and insert tasks for execution in emergencies, while ordinary developers can only perform basic operations such as task submission and status viewing. Through precise permission allocation and control, the system can effectively protect the security of user data, ensure the standardization of operations and the stable operation of the system. At the same time, this permission management mechanism enables the platform to flexibly adapt to the needs of different users, improving the maintainability and scalability of the system.

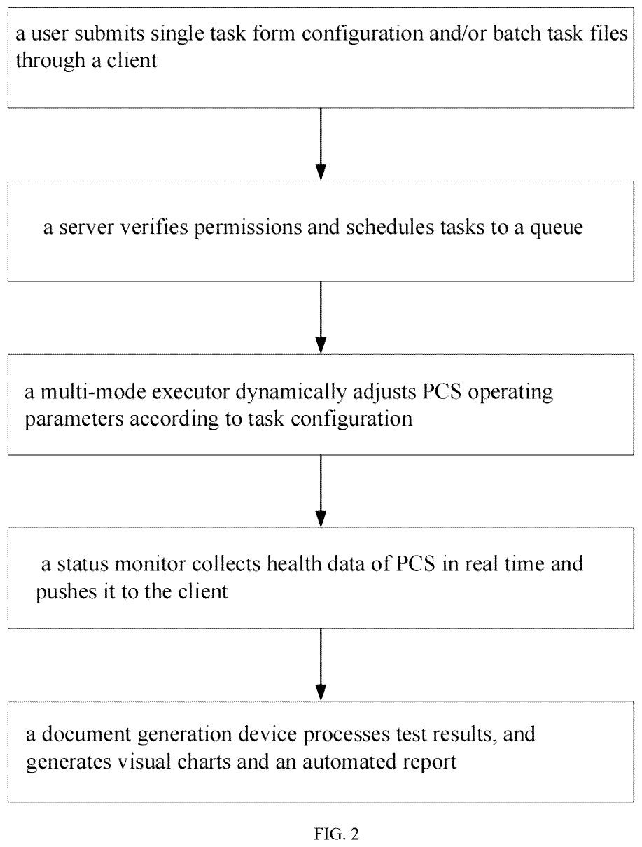

As shown in FIG. 2, the present disclosure also discloses a plasma control system test method, including the following steps:
S1. submitting, by a user, single task form configuration and/or batch task files through a client;
S2. verifying, by a server, permissions and scheduling tasks to a queue;
S3. dynamically adjusting, by a multi-mode executor, PCS operating parameters according to task configuration;
S4. collecting, by a status monitor, health data of PCS in real time and pushing it to the client;
S5. processing, by a document generation device, test results, and generating visual charts and an automated report.

Specifically, the user manually fills in various parameters of the test task through the graphical interface, such as test type, test mode, required equipment, etc. After filling in, the client packages these configuration parameters into a data file with JSON format and submits it to the server. The user can also choose to batch upload task configuration files. Each line in the file defines a complete set of test task configurations. The client performs format validation on these files to ensure the task format meets the requirements and converts each task configuration item into JSON format and uploads it to the server for processing.

After the server's identity verification device is configured to receive the task data submitted by the client, it first verifies the identity of the submitting user. Based on the user's role in the system (such as administrator, core developer, or ordinary developer), the identity verification device is configured to determine whether the user has the permission to submit tasks and perform related operations. After identity verification is passed, the task upload device is configured to parse the task data and transmit it to the task queue scheduler. The task queue scheduler determines the insertion position of the task in the queue based on the task's priority (set by the user during submission). If the task is a privileged task, it may be inserted at the head of the queue, while regular tasks are queued in the order of submission.

The multi-mode executor obtains the task to be executed from the task queue and reads the specific configuration of the task. According to the task configuration, the multi-mode executor dynamically adjusts the operating parameters of PCS (Plasma Control System). These parameters may include test mode, hardware configuration, simulation control parameters, etc. If the task is configured for scenario replay mode, the executor adjusts the PCS operating mode to runsa in the configuration file and starts the PCS process to replay historical experimental data; if the task is configured for simulation test mode, the executor the PCS operating mode to runsim in the configuration file and starts both PCS and PCS-VP processes to perform simulation testing and data acquisition.

The server's status monitor device is configured to obtain the health status of PCS in real time by subscribing to the health information of PCS published by the open-source distributed control system framework. These data include system operating status, hardware health status, connection status, etc. Once the health data is collected, the status monitor integrates this information and pushes it to the client through WebSocket. The client receives the real-time updated PCS health data and refreshes the interface. The user can view the status of the system in real time on the client interface, ensuring the stability of the test.

After the test task is completed, the document generation device is configured to process the generated test results, including obtaining experimental data and analysis result summaries from the database. The document generation device is configured to generate relevant visual charts based on the analysis results, such as flat-top segment waveform diagrams, boundary offset diagrams, etc. The charts display the time variation of the test data, key performance indicators, etc. By calling the general large language model, the document generation device is configured to automatically generate a test report based on the test results and analysis summary. This report includes descriptions of the test process, result analysis, chart displays, etc., and the report format is a structured document, which is convenient for users to view, archive, and share.

By adopting the above technical solution, the plasma control system test method can comprehensively cover all links from task submission, permission verification, task execution, status monitoring to result processing. By dynamically adjusting PCS operating parameters, the system can make flexible responses to different test requirements; through real-time health data acquisition and pushing, users can monitor the status of the system in real time, ensuring the stability and reliability of the test; the document generation device greatly improves work efficiency and reduces manual operation errors by automatically generating test reports and visual charts. The implementation of this test method makes the testing process more efficient and precise, providing powerful tool support for developers.

The present disclosure also discloses a non-transitory computer-readable storage medium, storing a computer program that, when executed by a processor, causes the processor to implement the steps of the method as described above.

The above descriptions are only preferred embodiments of the present disclosure and do not limit the patent scope of the present disclosure. Any equivalent structural transformations made under the inventive concept of the present disclosure using the contents of the specification and drawings of the present disclosure, or direct/indirect applications in other related technical fields are included in the patent protection scope of the present disclosure.

What is claimed is:

1. A plasma control system test platform, comprising:
a client, provided with a task submission device and an interactive visualization device, wherein the task submission device is configured to support single task form configuration and/or batch task file upload;
a server, provided with a task upload device, a task queue scheduler, a multi-mode executor, and a data analysis device; wherein the task upload device is configured to receive tasks uploaded by the client, and after parsing the tasks, send them to the task queue scheduler; the task queue scheduler, according to priority, performs insertion or queuing of uploaded tasks; the multi-mode executor is connected to PCS and PCS-VP, the multi-mode executor obtains the head task of the task queue, and according to the task mode, starts a PCS process to execute the task or simultaneously starts PCS and PCS-VP processes to execute the task; after task execution is completed, the data analysis device is configured to obtain raw execution data, process the data, and feed the processed data back to the client interactive visualization device; the task mode comprises: a scenario replay mode and a simulation test mode; when the multi-mode executor determines that the mode is the scenario replay mode, it modifies the PCS operating mode to runsa in the configuration file, starts the PCS process, calls a simulated central control system device to generate a hardware trigger signal, and the signal outputs a high-level pulse through an NI I/O card; when the multi-mode executor determines that the mode is the simulation test mode, it modifies the PCS operating mode to runsim in configuration file, starts the PCS and PCS-VP processes; transmits control signals to PCS-VP through shared memory, and receives simulated acquisition signals and feeds them back to PCS to form a closed loop.

2. The plasma control system test platform according to claim 1, wherein, according to priority, performing insertion or queuing of uploaded tasks comprises:
the task queue scheduler is configured to obtain task priority, determine whether the current priority is a privileged task; if it is a privileged task, query whether there is an uncompleted privileged task in the current queue; if there is an uncompleted privileged task, insert a new privileged task after the most recent privileged task; if there is no uncompleted privileged task, insert the new privileged task at the head of the queue;
if it is not a privileged task, the task queue scheduler is configured to insert the task at the tail of the queue, and after task execution is completed, delete the head task and update the database status field.

3. The plasma control system test platform according to claim 1, wherein, processing the data, and feeding the processed data back to the client interactive visualization device comprises:
the data analysis device is configured to read experimental shot data and historical reference shot data from a database storing raw execution data, identify flat-top segments in the experimental shot data and historical reference shot data, perform flat-top segment waveform analysis and boundary offset Euclidean distance calculation, store intermediate results as target format files, record the paths in a test shot table in the database, and feed analysis results back to the client's interactive visualization device, wherein the interactive visualization device is configured to display visual charts.

4. The plasma control system test platform according to claim 3, wherein, the client is further provided with a document generation device, wherein the document generation device is configured to obtain the paths of the visual charts displayed by the interactive visualization device, a summary of analysis results, and custom annotations, call a general large language model to integrate the visual charts, the summary of analysis results, and the custom annotations, and generate a structured document.

5. The plasma control system test platform according to claim 1, wherein, the server is further provided with a status monitor device, wherein the status monitor device is configured to subscribe to health information of PCS published by an open-source distributed control system framework, integrate the platform's own operating status, push the integrated status data to the client through WebSocket, and trigger real-time refresh of the client interface.

6. The plasma control system test platform according to claim 1, wherein, the client is provided with an identity authentication device, the server is provided with an identity verification device, wherein the identity verification device is configured to receive identity data from the identity authentication device, when the identity data is for new user registration, store the identity data, and feed back a registration result; when the identity data is historical data, compare the identity data with its own database, and distribute corresponding permissions.

7. The plasma control system test platform according to claim 6, wherein, the permissions comprise: administrator, core developer, and ordinary developer.

8. A plasma control system test method, configured for the plasma control system test platform according to claim 1 and comprising the following steps:
S1. submitting, by a user, single task form configuration and/or batch task files through a client;
S2. verifying, by a server, permissions and scheduling tasks to a queue;
S3. dynamically adjusting, by a multi-mode executor, PCS operating parameters according to task configuration;
S4. collecting, by a status monitor, health data of PCS in real time and pushing it to the client;
S5. processing, by a document generation device, test results, and generating visual charts and an automated report.

9. A computer-readable storage medium, storing a computer program that, when executed by a processor, causes the processor to implement the steps of the method according to claim 8.
